(19) United States
(12) Patent Application Publication
(10) Pub. No.: US 2026/0150805 A1
(43) Pub. Date: Jun. 4, 2026

(54) PET CAGE

(71) Applicant: Guangzhou Sair Industrial Co.,Ltd, Guangzhou (CN)

(72) Inventor: JIYE GUO, Guangzhou (CN)

(21) Appl. No.: 19/019,679

(22) Filed: Jan. 14, 2025

(30) Foreign Application Priority Data
Dec. 4, 2024 (CN) 202422992288.7

(51) Int. Cl. A01K 1/02

(52) U.S. Cl. CPC A01K 1/0245

(57) ABSTRACT

A pet cage, comprising a cage frame and a soft body for wrapping the cage frame, wherein the cage frame comprises an upper frame and a lower frame, the bottom of the upper frame is pivotably connected to one side of the lower frame, and the upper frame pivotably moves toward the lower frame or departs the lower frame, folding or unfolding the cage frame; a locking mechanism is further provided for locking the upper frame and the lower frame after the cage frame is unfolded.

### CROSS-REFERENCE TO RELATED APPLICATIONS

This application claims priority to Chinese Patent Application No. 202422992288. 7, filed on Dec. 4, 2024, which is hereby incorporated by reference in its entirety.

### TECHNICAL FIELD

The present invention relates to the technical field of pet products, particularly to a pet cage.

### BACKGROUND

In nowadays, keeping a pet has become an increasingly popular way of life. As human spiritual companions, pets have received more and more care and attention from humans, and various pet products have emerged. Existing pet cages, mostly made of aviation boxes or steel wire bars assembled together, can serve as cages, but are inconvenient to carry outdoors due to their large size or complicated assembly. Therefore, a portable pet cage is designed to address the above problems.

### SUMMARY

The main objective of the present invention is to propose a pet cage aimed at optimizing the structure of existing pet cages and improving their portability.

To achieve the above objectives, the present invention proposes a pet cage, comprising a cage frame and a soft body for wrapping the cage frame, wherein the cage frame comprises an upper frame and a lower frame, the bottom of the upper frame is pivotably connected to one side of the lower frame, and the upper frame swings along the pivot connection between a position close to the lower frame and a position far away from the lower frame, folding and unfolding the cage frame; a locking mechanism is further provided for locking the upper frame and the lower frame after the cage frame is unfolded.

Preferably, the upper frame and lower frame are directly pivotably connected, or the lower frame is provided with a connecting seat for pivotal connection with the upper frame.

Preferably, the upper frame and lower frame are a first U-shaped member and a second U-shaped member, respectively, and the two ends of the second U-shaped member are provided with the connecting seats, and the two ends of the first U-shaped member are pivotably connected to the two connecting seats, respectively.

Preferably, the pet cage further comprises a reinforcing rod wherein the two ends of the reinforcing rod are connected to the two connecting seats, respectively.

Preferably, the pet cage further comprises a linkage mechanism, wherein the linkage mechanism comprises a first swing arm, a second swing arm, and a third swing arm; one end of the first swing arm is pivotably connected to the cage frame, and the other end swings between a position close to the upper frame and a position close to the lower frame, first swing arm is movably installed with a movable seat that performs reciprocating motion along a length direction of the first swing arm, and the two ends of the second swing arm are articulated with the upper frame and moving seat (64), respectively, and the two ends of the third swing arm are articulated with the lower frame and moving seat, respectively;
when the cage frame is unfolded, the second swing arm and third swing arm drive the moving seat to move towards the free end of the first swing arm, and when the cage frame is folded, the second swing arm and third swing arm drive the moving seat to move towards the pivot end of the first swing arm.

Preferably, the pet cage further comprises a third U-shaped component, wherein the cage frame has two linkage mechanisms, and the two ends of the third U-shaped component are connected to the free ends of the two first swing arms, respectively.

Preferably, the first swing arm runs through to form a strip hole extending along a length direction of the first swing arm, and the moving seat is provided with a limit shaft passing through the strip hole, and the limit shaft moves in the strip hole with the movement of the moving seat.

Preferably, the locking mechanism comprises a locking member movably disposed on the moving seat, the first swing arm is provided with a locking position into which the locking member is partially fitted, the locking member moves, with the movement of moving seat, between the position where the locking member is partially fitted into locking position and position where the locking member is away from locking position, and the locking member that is partially fitted into the locking position restricts the movement of moving seat to lock the upper frame and lower frame.

Preferably, the locking mechanism further comprises a top spring for applying an elastic force that causes the locking member to move in a direction where the locking member is partially fitted into the locking position.

Preferably, the locking member is provided with a driving portion exposed outside the moving seat.

Preferably, the soft body has at least one inlet and outlet that connects the internal space of pet cage with the outside, and the inlet and outlet are opened or closed through a zipper structure, a buckle structure, or a Velcro structure.

Preferably, the soft body further has a connection structure for fitted connection with the car seat, and the pet cage is fixed to the car seat through the connection structure.

In the technical solution of the present invention, a pet cage that combines a cage frame and soft body can accommodate pets, the cage frame comprises an upper frame and a lower frame that are pivotably connected to each other, the upper frame can swing along the pivot connection position to approach or move away from the lower frame, such that the cage frame can be folded or unfolded, and the upper frame and lower frame can be locked by a locking mechanism after the cage frame is unfolded. Compared with traditional ones, the pet cage has a simple structure as a whole and features convenient folding and unfolding, and the folded pet cage has a significantly reduced occupied space and effectively improved portability.

### BRIEF DESCRIPTION OF DRAWINGS

FIG. 1 is a schematic diagram of the soft body;

FIG. 2 is a schematic diagram of cage frame in the unfolded state;

FIG. 3 is a schematic diagram of cage frame in the folded state;

FIG. 4 is a sectional view of the first swing arm, moving seat, and locking member.

### DESCRIPTION OF EMBODIMENTS

The technical solutions in the embodiments of present invention will be described clearly and completely in conjunction with the accompanying drawings of the embodiments of the present invention. Obviously, the described embodiments are only a part of the embodiments of the present invention, rather than all the embodiments. Based on the embodiments of the present invention, all other embodiments obtained by those of ordinary skill in the art without creative work shall fall within the protection scope of the present invention.

It should be noted that all directional indicators (such as up, down, left, right, front, back, top, bottom, inside, outside, vertical, horizontal, longitudinal, counterclockwise, clockwise, circumferential, radial, axial . . .) in the embodiments of the present invention are only used to explain the relative position relationship and movement among various components in a particular posture (as shown in the accompanying drawings), and if that particular posture is changed, the directional indications will change accordingly.

In addition, descriptions involving terms “first,” “second” and the like, if any, in the present invention are only for illustrative purposes and cannot be understood as indicating or implying relative importance or the number of features referred to. Therefore, the features defined with “first” and “second” may explicitly or implicitly include at least one or a plurality of the features. At the same time, the technical solutions of various embodiments can be combined with each other, but must be based on what those of ordinary skill in the art can achieve. The combination of technical solutions that result in contradiction or make it impossible to o implement should be considered non-existent, and accordingly should not fall within the scope of protection required by this present invention.

The present invention proposes a pet cage.

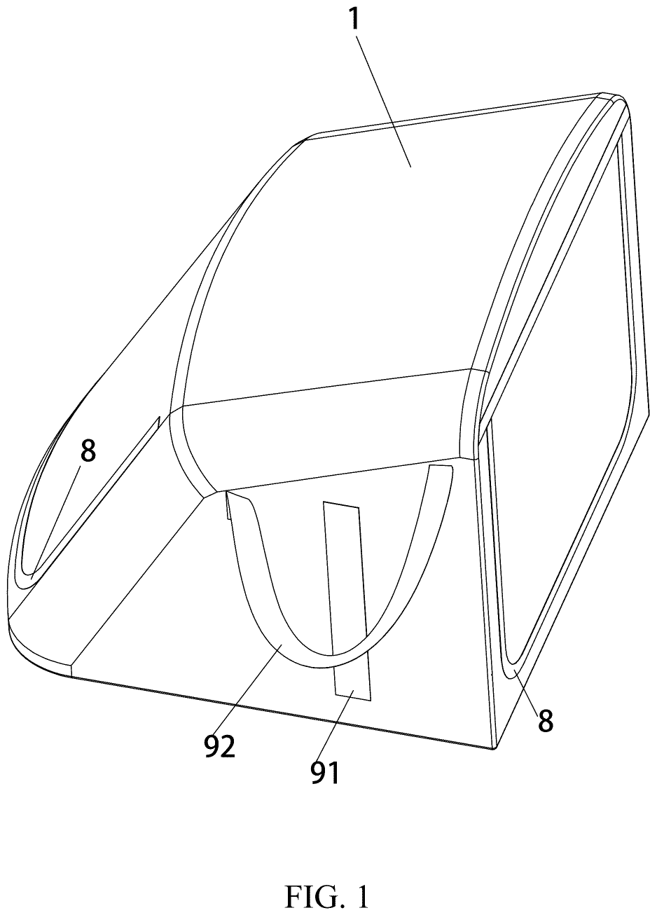

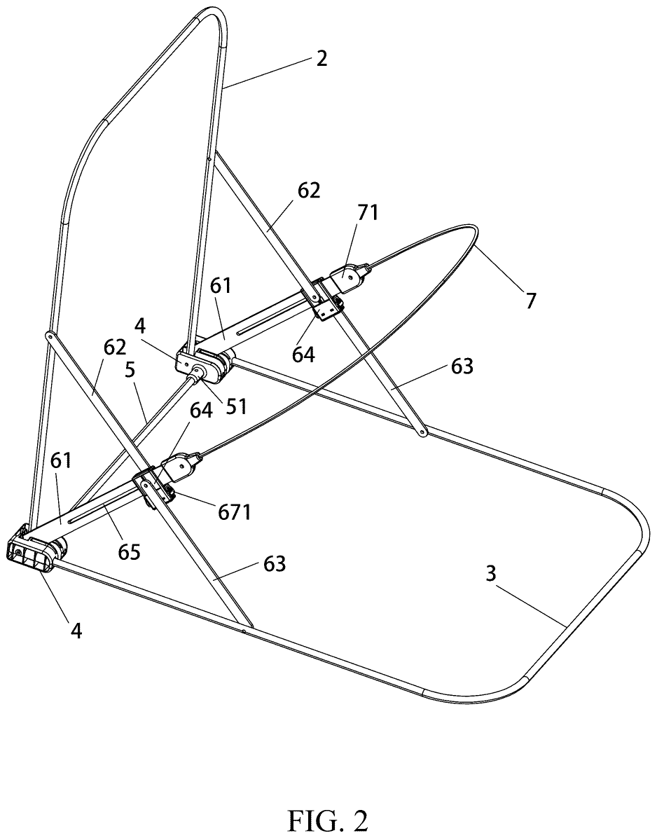

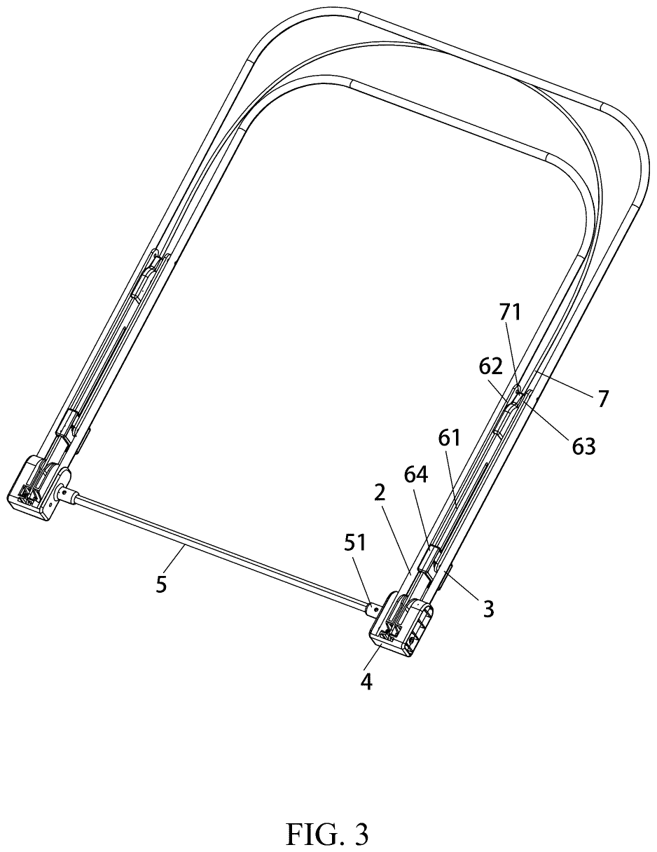

In the embodiments of the present invention, as shown in FIG. 1 to 4, the pet cage, comprises a cage frame and a soft body 1 for wrapping the cage frame, wherein the cage frame comprises an upper frame 2 and a lower frame 3, the bottom of the upper frame 2 is pivotably connected to one side of the lower frame 3, and the upper frame 2 swings along the pivot connection between a position close to the lower frame 3 and a position far away from the lower frame 3, folding and unfolding the cage frame; a locking mechanism is further provided for locking the upper frame 2 and the lower frame 3 after the cage frame is unfolded.

Specifically, the upper frame 2 and lower frame 3 are directly pivotably connected, or the lower frame 3 is provided with a connecting seat 4 for pivotal connection with the upper frame 2.

Specifically, the upper frame 2 and lower frame 3 are a first U-shaped member and a second U-shaped member, respectively, and the two ends of the second U-shaped member are provided with the connecting seats 4, and the two ends of the first U-shaped member are pivotably connected to the two connecting seats 4, respectively.

Specifically, the end of the second U-shaped member, after being plugged into the connecting seat 4, is locked by screws.

Specifically, the pet cage further comprises a reinforcing rod 5, wherein the two ends of the reinforcing rod 5 are connected to the two connecting seats 4, respectively.

Specifically, the connecting seat 4 has a socket 51 on one side near the reinforcing rod 5, and after the end of the reinforcing rod 5 is inserted into the socket 51, both the reinforcing rod 5 and socket 51 are locked by screws.

Specifically, the pet cage comprises a linkage mechanism, wherein the linkage mechanism comprises a first swing arm 61, a second swing arm 62, and a third swing arm 63; one end of the first swing arm 61 is pivotably connected to the cage frame, and the other end swings between a position close to the upper frame 2 and a position close to the lower frame 3, first swing arm 61 is movably installed with a movable seat 64 that performs reciprocating motion along a length direction of the first swing arm 61, and the two ends of the second swing arm 62 are articulated with the upper frame 2 and moving seat 64, respectively, and the two ends of the third swing arm 63 are articulated with the lower frame 3 and moving seat 64, respectively;
when the cage frame is unfolded, the second swing arm 62 and third swing arm 63 drive the moving seat 64 to move towards the free end of the first swing arm 61, and when the cage frame is folded, the second swing arm 62 and third swing arm 63 drive the moving seat 64 to move towards the pivot end of the first swing arm 61. When the cage frame is unfolded and folded, the combined linkage between the second swing arm 62, third swing arm 63 and the moving seat drives the first swing arm 61 to perform linkage action.

The articulated end of the first swing arm 61 is specifically articulated with the connecting seat 4.

Specifically, the pet cage further comprises a third U-shaped component 7, wherein the cage frame has two linkage mechanisms, and the two ends of the third U-shaped component 7 are connected to the free ends of the two first swing arms 61, respectively.

Specifically, the end of the third U-shaped component has a connector 71, and the connector 71 is inserted into the free end of the first swing arm 61 and then locked by screws.

Specifically, the first swing arm 61 runs through to form a strip hole 65 extending along a length direction of the first swing arm 61, and the moving seat 64 is provided with a limit shaft 66 passing through the strip hole 65, and the limit shaft 66 moves in the strip hole 65 with the movement of the moving seat 64.

Specifically, the two ends of the limit shaft 66 extend to be exposed and are hinged to the second swing arm 62 and the third swing arm 63, respectively.

Specifically, the locking mechanism can refer to prior art, or, the locking mechanism comprises a locking member 67 movably disposed on the moving seat 64, the first swing arm 61 is provided with a locking position 68 into which the locking member 67 is partially fitted, the locking member 67 moves, with the movement of moving seat 64, between the position where the locking member 67 is partially fitted into locking position 68 and position where the locking member 67 is away from locking position 68, and the locking member 67 that is partially fitted into the locking position 68 restricts the movement of moving seat 64 to lock the upper frame 2 and lower frame 3.

Specifically, the locking mechanism further comprises a top spring 69 for applying an elastic force that causes the locking member 67 to move in a direction where the locking member 67 is partially fitted into the locking position 68. When the end of locking member 67 is not fitted into the locking position 68, the elastic force applied by the top spring 69 forces the end of locking member 67 to maintain elastic contact with the outer wall of first swing arm 61, and when the moving seat 64 moves to cause a part of locking member 67 align with the locking position 68, the elastic force applied by the top spring 69 will cause the locking member 67 partially fit into the locking position 68 automatically, thereby achieving automatic locking.

Specifically, the locking member 67 is provided with a driving portion 671 exposed outside the moving seat 64. Unlocking can be realized by manually driving the end of locking component 67 through driving portion 671 disengage from the locking position 68.

Specifically, as shown in the figure, the moving seat 64 has a first mounting hole 641 and a second mounting hole 642, the moving seat 64 is movably sleeved on the first swing arm 61 through the first mounting hole 641, the first mounting hole 641 and second mounting hole 642 are connected through a perforation 643, the locking member 67 is movably installed in the second mounting hole 642, and the locking member 67 is partially and movably fitted into the perforation 643, the portion inserted into the perforation 643 can move, with the movement of locking member 67, between a position where the the portion enters the first mounting hole 641 and is snapped into the locking position 68 and a position where the portion is away from the locking position 68; the locking member 67 is in a long strip shape, and both ends of the locking member 67 extend out of the moving seat 4 in an exposed state and forms the driving portion 671. The locking member 67 enters the second mounting hole 642 through the opening of the second mounting hole 642, and therefore a cover body 644 is also provided, and the cover body 644 is locked by screws or fixed to the moving seat 64 through a buckle structure and closes the opening of the second mounting hole 642.

Specifically, the surface of driving portion 671 is formed with anti slip patterns.

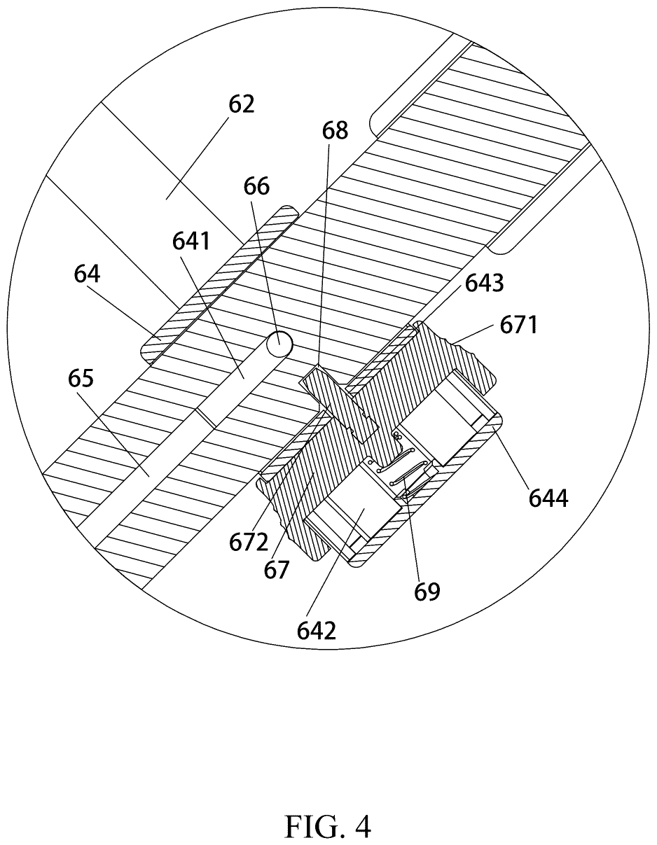

Specifically, the portion inserted into the perforation 643 can be integrally formed with the locking member 67, or can be a pin 672 fixedly connected to the locking member 67 as shown in FIG. 4.

Specifically, the soft body 1 has at least one inlet and outlet that connects the internal space of pet cage with the outside, and the inlet and outlet are opened or closed through a zipper structure 8, a buckle structure, or a Velcro structure, and in this embodiment, as shown in FIG. 1, through a zipper structure 8.

Specifically, the soft body 1 is partially a mesh structure.

Specifically, the soft body 1 further has a connection structure for fitted connection with the car seat, and the pet cage is fixed to the car seat through the connection structure.

The connection structure includes a first connection rope 91 and a second connection rope 92, and after the pet cage is placed on the car seat, the seat belt on the car seat can be led to pass through the position between the first connection rope 91 and the soft body 1 and to connect to the car seat to initially fix the pet cage, and the second connection rope 92 is then placed on the headrest of car seat to further fix the pet cage, so that the double fixation effectively improves the stability of pet cage during car driving.

In the technical solution of the present invention, a pet cage that combines a cage frame and soft body can accommodate pets, and the cage frame comprises an upper frame and a lower frame that are pivotably connected to each other, the upper frame can swing along the pivot connection position to approach or move away from the lower frame, such that the cage frame can be folded or unfolded, and the upper frame and lower frame can be locked by a locking mechanism after the cage frame is unfolded. Compared with traditional ones, the pet cage has a simple structure as a whole and features convenient folding and unfolding, and the folded pet cage has a significantly reduced occupied space and effectively improved portability.

The above are only the preferred embodiments of the present invention, and are not intended to limit the present invention. Any equivalent structural transformation made based on the description and accompanying drawings hereof under the concept of present invention, or be directly/indirectly applied in other related technical fields, should fall within scope of patent protection of the present invention.

1. A pet cage, comprising a cage frame and a soft body (1) for wrapping the cage frame, wherein the cage frame comprises an upper frame (2) and a lower frame (3), the bottom of the upper frame (2) is pivotably connected to one side of the lower frame (3), and the upper frame (2) pivotably moves toward the lower frame (3) or departs the lower frame (3), folding or unfolding the cage frame; a locking mechanism is further provided for locking the upper frame (2) and the lower frame (3) after the cage frame is unfolded;
further comprising a set of linkage mechanisms wherein the linkage mechanism comprises a set of first swing arms (61), a set of second swing arms (62), and a set of third swing arms (63); one end of the first swing arm (61) is pivotably connected to the cage frame forming the pivot end of the first swing arm (61), and the other end swings between a position close to the upper frame (2) and a position close to the lower frame (3), the first swing arm (61) is movably installed with a movable sea (64) that as reciprocating motion along a length direction of the first swing arm (61), and the two ends of the second swing arm (62) are articulated with the upper frame (2) and the movable seat (64), respectively, and the two ends of the third swing arm (63) are articulated with the lower frame (3) and the movable seat (64), respectively;
when the cage frame is unfolded, the second swing arm (62) and the third swing arm (63) drive the moving seat (64) to move towards the free end of the first swing arm (61), and when the cage frame is folded, the second swing arm (62) and the third swing arm (63) drive the movable seat (64) to move towards the pivot end of the first swing arm (61).
the first swing arm (61) runs through to form a strip hole (65) extending along a length direction of the first swing arm (61), and the movable seat (64) is provided with a limit shaft (66) passing through the strip bole (65), and the limit shaft (66) moves in the strip hole (65) along with the movable seat (64), the two ends of the limit shaft (66) extend out and are hinged to the second swing arm (62) and the third swing arm (63) respectively.

2. The pet cage according to claim 1, wherein the upper frame (2) and the lower frame (3) are directly and pivotably connected, or the lower frame (3) is provided with a set of connecting seats (4) for pivotal connection with the upper frame (2).

3. The pet cage according to claim 2, wherein the upper frame (2) is a first U-shaped member and the lower frame (3) is a second U-shaped member, and each end of the second U-shaped member is provided with a connecting seat (4), and each end of the first U-shaped member is pivotably connected to the connecting seat (4) correspondingly.

4. The pet cage according to claim 3, further comprising a reinforcing rod (5), wherein the two ends of the reinforcing rod (5) are connected to the connecting seats (4) respectively.

5. (canceled)

6. The pet cage according to claim 1, further comprising a third U-shaped component (7), the cage frame is provided with two said linkage mechanisms, and one end of the third U-shaped component (7) is connected to the free end of one of the first swing arms (61), and the other end of the third U-shaped component (7) is connected to the free end of the other first swing arm (61).

7. (canceled)

8. The pet cage according to claim 1, wherein the locking mechanism comprises a locking member (67) movably disposed on the movable seat (64), the first swing arm (61) is provided with a locking position (68) into which the locking member (67) is partially fitted, the locking member (67) moves, with the movement of the movable seat (64), between the position where the locking member (67) is partially fitted into the locking position (68) and the position where the locking member (67) is away from the locking position (68), and the locking member (67) that is partially fitted into the locking position (68) restricts the movement of the movable seat (64) to lock the upper frame (2) and the lower frame (3).

9. The pet cage according to claim 68, wherein the locking mechanism further comprises a top spring (69) to force the locking member (67) to move in a direction where the locking member (67) is partially fitted into the locking position (68).

10. The pet cage according to claim 8, wherein the locking member (67) is provided with a driving portion (671) exposed outside the movable seat (64).

11. The pet cage according to claim 1, wherein the soft body (1) has a set of inlet and outlet compounds that connects the internal space of the pet cage with the external space, and the inlet and outlet compound is opened or closed through a zipper structure (8), or a buckle structure.

12. The pet cage according to claim 1, wherein the soft body (1) further has a connection structure for fitting connection with a car seat, and the pet cage is fixed to the car seat through the connection structure.
